(19) United States
(12) Patent Application Publication
(10) Pub. No.: US 2012/0181342 A1
(43) Pub. Date: Jul. 19, 2012

(54) Automatic HVAC energy saver control unit

(76) Inventors: Jacqueline Richards-Fabian, Baltimore, MD (US); Alan B. Fabian, Baltimore, MD (US)

(21) Appl. No.: 13/136,756

(22) Filed: Aug. 10, 2011

Related U.S. Application Data
(60) Provisional application No. 61/401,434, filed on Aug. 12, 2010.

(51) Int. Cl. G05D 23/19

(52) U.S. Cl. 236/46 A; 236/51

(57) ABSTRACT

The Automatic HVAC Energy Saver Control Unit (HVAC-ES) is composed of 4 components. The Control System includes 2 wireless contacts, 1 transformer, and 1 control keypad. The Relay opens and closes the circuit. The Timer determines when the Relay engages and had dip switches and a timer dial that allows the delay to be set in seconds, minutes, or hours. The Cover encloses the Relay and Timer.

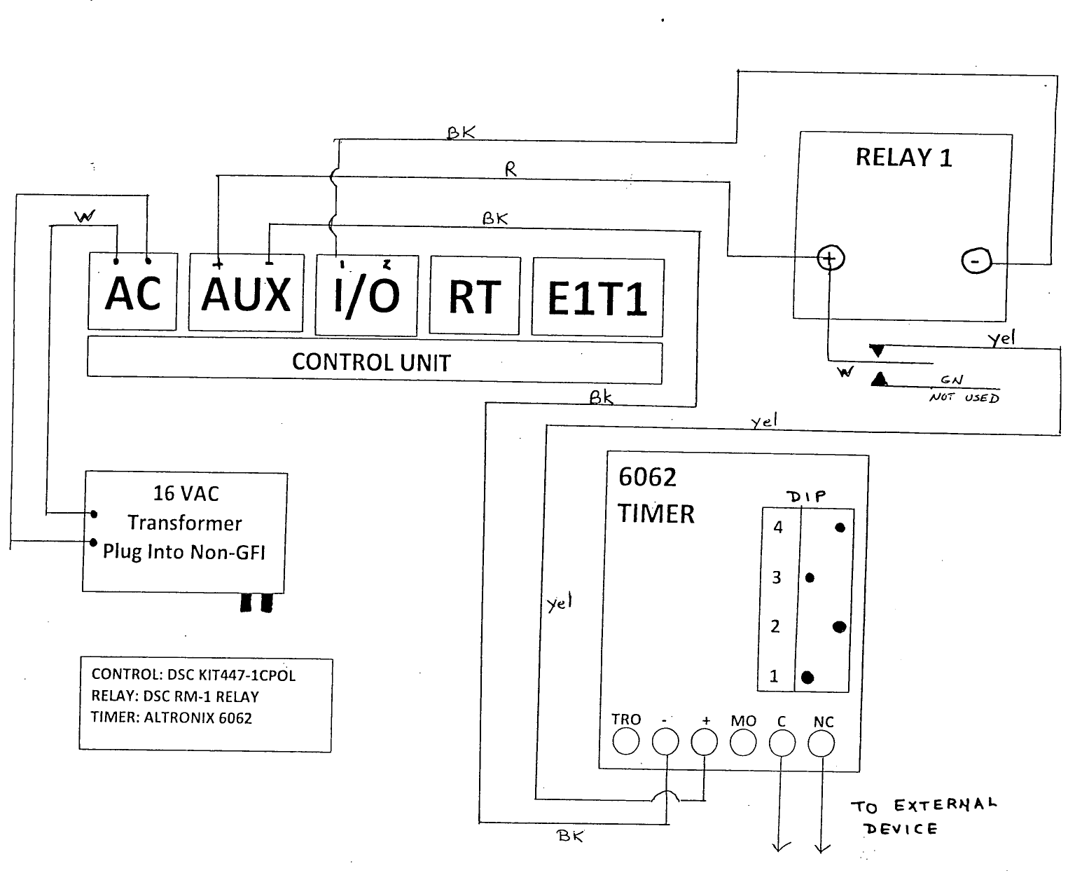

The HVAC-ES operates when a door or window fitted with the wireless contacts is left open beyond the programmed time. At that point, the relay engages and shuts off the power to the HVAC unit. Once the door or window is closed the relay disengages and the power to the HVAC unit is restored. The HVAC-ES is connected to the power wires between the thermostatic control and the HVAC unit.

Pursuant to 35 USCS §119(e) and MPEP §1.78(a)(5), this application claims the benefit of provisional application 61/401,434 filed on Aug. 12, 2010.

These documents are submitted pursuant to the Formalities Letter issued on Aug. 26, 2011. These corrections are submitted in compliance with 37 CFR 1.52, 1.121(b)(3), and 1.125. A marked up and a clean version are submitted. Pursuant to 1.125(b), this substitute specification contains no new matter.

### SPECIFICATIONS

The Automatic HVAC Energy Saver Control Unit (HVAC-ES) is composed of 4 components. The Control System includes 2 wireless contacts, 1 transformer, and 1 control keypad. The Relay opens and closes the circuit. The Timer determines when the Relay engages and had dip switches and a timer dial that allows the delay to be set in seconds, minutes, or hours. The Cover encloses the Relay and Timer.

The HVAC-ES is designed for any application in which user wishes to shut off the HVAC system automatically when doors and/or windows are opened. Its primary application is for vacation rental properties, hotels, and apartments where renters may be inclined to leave doors and windows open with the HVAC unit on. It is designed to be installed as a retrofit product for existing construction.

The operation of the HVAC-ES is simple. Wireless Contacts are installed on the desired doors and/or windows. The Timer is set to the desired delay time in seconds, minutes, or hours. The factory programmed delay will be 15 minutes. When the wireless contact is broken, the Timer is activated. If the contact remains broken for more than the delay set, the Relay is engaged and breaks the power circuit causing the HVAC shutdown. Once the wireless contacts are closed, the HVAC system will recycle and restart. The HVAC-ES installs between the thermostatic control and the HVAC unit. It connects to the + or − control wires that regulate the power on/off. The HVAC-ES is powered by a standard 120v outlet.

This application contains 1 drawing which is a schematic view of the HVAC-ES. The above specification references the schematic view only. This brief description of the view of the drawing is submitted in accordance with 37 CFR 1.74 and 37 CFR 1.77(b)(8).

1. Wireless Contacts are installed on the desired doors and/or windows. The Timer is set to the desired delay time in seconds, minutes, or hours. The factory programmed delay will be 15 minutes. When the wireless contact is broken, the Timer is activated. If the contact remains broken for more than the delay set, the Relay is engaged and breaks the power circuit causing the HVAC shutdown. Once the wireless contacts are closed, The HVAC system will recycle and restart. The HVAC-ES installs between the thermostatic control and the HVAC unit. It connects to the + or − control wires that regulate the power on/off. The HVAC-ES is powered by a standard 120v outlet.
